(19) United States
(12) Patent Application Publication
(10) Pub. No.: US 2025/0329477 A1
(43) Pub. Date: Oct. 23, 2025

(54) MOLTEN SALT NUCLEAR REACTOR AND METHOD OF AUTOMATIC SHUTDOWN OF SUCH NUCLEAR REACTOR

(71) Applicant: Copenhagen Atomics A/S, Kastrup (DK)

(72) Inventor: Aslak Stubsgaard, Copenhagen K (DK)

(73) Assignee: Copenhagen Atomics A/S, Kastrup (DK)

(21) Appl. No.: 19/121,078

(22) PCT Filed: Oct. 23, 2023
(86) PCT No.: PCT/DK2023/050253

§ 371 Date: Apr. 14, 2025

(30) Foreign Application Priority Data
Oct. 21, 2022 (DK) PA202270509

(51) Int. Cl. G21D 3/04; G21C 3/54; G21C 15/18; G21C 15/243

(52) U.S. Cl. CPC G21D 3/04; G21C 3/54; G21C 15/182; G21C 15/243

(57) ABSTRACT

The first invention describes a molten salt nuclear reactor system and method of controlling a nuclear reactor, the molten salt nuclear reactor being contained in a closed vessel of the molten salt nuclear reactor system, the molten salt nuclear reactor comprising: a reactor core, a circulation pump, a drain tank, a controller, and a liquid loop for circulating a liquid through the reactor core, wherein the controller is configured to autonomously stop reactor operation by allowing the liquid to drain into the drain tank under influence of gravity when at least one reactor parameter differs from acceptable operating values, and/or wherein the controller is configured to commence reactor operation by starting the circulation pump to pump liquid from the drain tank to the liquid loop when all reactor parameters are in conformity with the acceptable operating values. The second invention describes a molten salt nuclear reactor and method for maintaining a sustained nuclear fission chain reaction, the nuclear reactor comprising a vessel (1) having an interior (30,35), the nuclear reactor further comprising in the interior of the vessel: a nuclear reactor core (2); a molten salt primary heat exchange loop (3) comprising a molten salt primary heat exchange medium pump; at least one sensor (9,22,41,49 and the base, 59, 79) configured to provide a signal representative of an operation state of the nuclear reactor; a primary heat exchanger (10) through which the primary heat exchange loop passes; and a breaker circuit arrangement (18,28,68) comprising a circuit breaker (19, 29, 69) and configured to connect and disconnect at least one of electric and/or electronic components (5,15,45) in the interior to and from a source of electric power (53) inside the vessel (1); the circuit breaker (19,29,69) having an open and a closed state; the breaker circuit arrangement (18,28,68) being connected to the at least one sensor (9.22.41.49.59.79); and the breaker circuit arrangement (18,28,68) being configured to open a circuit breaker (19,29,69) when the signal from the at least one sensor (9.22.41.49.59.79) exceeds a safety threshold.

### TECHNICAL FIELD

The disclosure relates to nuclear reactors and methods of controlling such a nuclear reactor, in particular to the construction and design of a nuclear reactor that automatically shut down when needed and methods of automatic shutdown of such nuclear reactors.

### BACKGROUND

The most common nuclear reactors are large and complicated pressurized water reactors (PWR) or boiling water reactors (BWR). Both PWRs and BWRs use ordinary water as both coolant and moderator and commonly rely on active systems, such as backup diesel generators for safety, i.e. these reactors are not inherently safe. These nuclear reactors are controlled by a team of human operators from a control room. The complexity of these nuclear reactors, the complexity of their control, and the involvement of the plurality of human operators in the control of the nuclear reactor causes these common nuclear reactors to be expensive to operate and also leaves room for improving safety and reliability.

Many advanced nuclear reactor types can be made passively safe so that their operation does not need active backup systems. Such reactors are generally considered safer than traditional reactor types, like PWRs and BWRs because they do not rely on human or machine intervention to shut the reactor down safely in case of an emergency. Passively safe reactor concepts have been proposed within different reactor categories, among them are molten salt reactors (MSR), High-temperature gas-cooled reactors, liquid metal cooled solid fuel reactors, and a few advanced water reactors.

The primary safety function of a nuclear reactor is to prevent the release of radionuclides, both during normal operation, shutdown, or accident conditions. It has often been in part the role of human nuclear operators to make sure a reactor is controlled to prevent the release of radionuclides. It is a desire to develop new reactor concepts that can achieve this function without the need for human intervention, instead relying on the inherent safety of the design.

A molten salt reactor (MSR) is a nuclear reactor where the nuclear reactor coolant and/or the nuclear fuel is a molten salt, typically a fluoride or chloride salt, with a melting point of around ˜500° C., an operating temperature of around ˜600 to 700° C., and a boiling point of ˜1000° C. above the melting point. One of the many advantages of this type of reactor is that molten salts can be used as the heat transfer media at very high temperatures while still operating at or close to atmospheric pressure. Heat is extracted from such reactors by pumping the molten salt in a loop or by natural convection between the nuclear reactor core and a heat exchanger with the reactor power being directly proportional to the temperature drop across the heat exchanger and the flow rate. Due to their large negative temperature and void coefficients, molten salt reactors can be designed and constructed to be inherently self-regulating and have passive decay heat removal and are thus referred to as inherently safe. JP2016176821A discloses a nuclear reactor with a monitoring unit monitoring the operation of the nuclear reactor using thermoacoustic sensors in the nuclear reactor core.

WO2021141882 discloses a sensor assembly for determining an operating characteristic of a nuclear reactor. The sensor assembly includes a solid-state lasing media doped with a fissile species and disposable within a core of the nuclear reactor and an optical fiber operably coupled to the solid-state lasing media and configured to extend out of the core of the nuclear reactor and to control system of the nuclear reactor. The fissile species include one or more of uranium, plutonium, americium, or californium. A method of determining an operating characteristic of a nuclear reactor includes during operation of the nuclear reactor; receiving from the optical fiber a laser light, analyzing the laser light, and based on the analysis of the laser light, determining the operating characteristic of the nuclear reactor.

In order to make nuclear reactors mass deployable, there is a desire to have their cost of deployment lowered and increase their safety and reliability.

### SUMMARY

It is an object to provide a nuclear reactor that overcomes or at least reduces one of the problems above.

The foregoing and other objects are achieved by the features of the independent claims. Further implementation forms are apparent from the dependent claims, the description, and the figures.

According to a first expect there is provided molten salt nuclear reactor for supplying heat to a consumer of heat, the molten salt nuclear reactor being contained in a closed and preferably leaktight vessel, the molten salt nuclear reactor comprising:
a reactor core,
a liquid loop for circulating a liquid through the reactor core, the liquid being a moderator or a mixture of molten salt and nuclear fuel,
the liquid loop comprises a circulation pump for circulating the liquid,
a drain tank, and
a controller configured to monitor one or more reactor parameters,
the controller having stored acceptable operating values or ranges for the one or more reactor parameters,
and the controller being configured to:
   autonomously stop reactor operation by allowing the liquid to drain into the drain tank under the influence of gravity when at least one or a combination of the reactor parameters differs from the acceptable operating values or ranges and/or
   autonomously commence reactor operation by starting the circulation pump to pump liquid from the drain tank to the liquid loop and to circulate liquid in the liquid loop when all reactor parameters and combinations thereof are in conformity with the acceptable operating values or ranges.

By providing a molten salt nuclear reactor with a controller that is configured to potentially stop reactor operation by allowing the liquid in the liquid loop liquid to drain into a drain tank under the influence of gravity, a very high level of passive safety is provided.

According to a possible implementation form of the first aspect, the reactor parameters comprise one or more thermodynamic conditions of the liquid and/or a parameter indicating whether or not heat is consumed by the consumer of heat.

According to a possible implementation form of the first aspect, the nuclear reactor comprises one or more sensors configured to issue a signal representative or indicative of the one or more reactor parameters to the controller

According to a possible implementation form of the first aspect, the controller is configured to derive the one or more reactor parameters from the signals from the one or more sensors.

According to a possible implementation form of the first aspect, the one of the one or more sensors comprise one or more of:
a temperature sensor configured for sensing the temperature of the liquid, preferably at a position at or near a liquid inlet or outlet of the reactor core,
a temperature sensor configured for sensing of the atmosphere in the closed vessel,
a gas composition sensor configured for sensing of the atmosphere in the closed vessel,
a radiation detection sensor configured for detecting a radiation level in the closed vessel,
a leak detection sensor, configured for detecting a leak in the liquid loop,
a seismic sensor configured to detect seismic events affecting the molten salt nuclear reactor,
a pump speed sensor configured to detect the speed of the circulation pump,
a flow rate sensor configured to detect the flow rate of the liquid circulating in the liquid circuit,
a liquid level sensor, configured for detecting a liquid level in the drain tank,
a door sensor configured for detecting if a door in the closed vessel is open or closed.

According to a possible implementation form of the first aspect, the liquid loop, the drain tank and the circulation pump are configured to allow the liquid to drain to the drain tank under the influence of gravity when the circulation pump is stopped.

According to a possible implementation form of the first aspect, the drain tank is configured to remove heat from any liquid in the drain tank, preferably decay heat from a liquid containing fissile material, the drain tank preferably comprising passive cooling means for removing heat from the drain tank.

According to a possible implementation form of the first aspect, the circulation pump is of an open type that is open for passage of the liquid when the circulation pump is not operating, and/or wherein the drain tank is fluidically connected to the liquid loop via a normally open valve and/or wherein the drain tank is part of the liquid loop.

According to a possible implementation form of the first aspect, the liquid loop is either a moderator loop for circulating a liquid moderator, preferably comprising heavy water, or a heat exchange loop for circulating a heat exchange medium, preferably molten salt or a mixture of molten salt and nuclear fuel.

According to a possible implementation form of the first aspect, the nuclear reactor comprises the controller being configured to derive the one or more reactor parameters and/or the one or more thermodynamic conditions from signals from sensors that are arranged inside the vessel.

According to a possible implementation form of the first aspect, the controller comprises one or more of: analog electronics, digital electronics, mechanical logic, fluidic logic, a proportional-integral-derivative controller, a model predictive controller, a Boolean controller.

According to a possible implementation form of the first aspect, the nuclear reactor comprises at least one circuit breaker arranged between a source of electrical power in the closed vessel and an electric device, the electric device being configured to stop a machine driving the circulation pump and/or to allow the normally open valve to assume its normally open position.

By providing a circuit breaker that is triggered by a signal sensor configured to provide a signal representative of an operation state of the molten salt nuclear reactor it is possible to create a nuclear reactor that automatically shuts down in a safe manner when the reactor approaches or reaches an unsafe state without needing human intervention, thereby significantly reducing risk of human error.

According to a possible implementation form of the first aspect, the controller is configured to open the circuit breaker to stop nuclear reactor operation by opening the at least one breaker circuit to thereby interrupt supply of electric power to the electric device.

According to a possible implementation form of the first aspect, the circuit breaker and the controller are part of a circuit breaker arrangement.

According to a possible implementation form of the first aspect, the electric device is an electric motor operably coupled to the circulation pump, and/or wherein the electric device is an actuator operably coupled to the normally open valve, and/or wherein the electric device is an actuator operably coupled to a normally closed valve in a supply conduit of a fluid driven motor that drives the circulation pump.

According to a possible implementation form of the first aspect, the nuclear reactor is configured to end the nuclear reaction and enter a safe state upon the controller ending reactor operation.

According to a second aspect, there is provided a method of controlling a molten salt nuclear reactor, the molten salt nuclear reactor being configured to supply heat to a consumer of heat and is contained in a closed and preferably leaktight vessel, the molten salt nuclear reactor comprising:
a liquid loop for circulating a liquid through the reactor core, the liquid being a moderator or a mixture of molten salt and nuclear fuel,
the liquid loop comprises a circulation pump for circulating the liquid,
a drain tank, and
a controller having stored acceptable operating values or ranges for the one or more reactor parameters,
the method comprising:
the controller monitoring the one or more reactor parameters,
the controller autonomously stopping reactor operation by allowing all the liquid to drain from the liquid loop into the drain tank under the influence of gravity when at least one or a combination of the reactor parameters differs from the acceptable operating values or ranges and/or
the controller autonomously stopping reactor operation by allowing all the liquid to drain into the drain tank under the influence of gravity when a reactor parameter indicates that no heat is consumed by the consumer of heat, and/or
the controller autonomously commencing reactor operation by starting the circulation pump to pump liquid from the drain tank into the liquid loop and to circulate liquid in the liquid loop when at all reactor parameters and combinations thereof are in conformity with the acceptable operating values or ranges.

According to a possible implementation form of the second aspect, the reactor comprises one or more sensors configured to issue a signal representative or indicative of the one or more reactor parameters and wherein the method comprises deriving the one or more reactor parameters from the signals from the one or more sensors.

According to a possible implementation form of the second aspect, the method comprises allowing the liquid to drain to the drain tank under the influence of gravity when the circulation pump is stopped.

According to a possible implementation form of the first aspect, the reactor comprises at least one circuit breaker arranged between a source of electrical power in the closed vessel and an electric device, the electric device being configured to stop a machine driving the circulation pump and/or to allow a normally open valve to assume its normally open position, the method comprising opening the at least one breaker circuit when at least one or a combination of the reactor parameters differs from the acceptable operating values or ranges and/or when a reactor parameter indicates that no heat is consumed by the consumer of heat.

According to a third aspect, there is provided a molten salt nuclear reactor for maintaining a sustained nuclear fission chain reaction, the nuclear reactor comprising a closed and preferably leaktight vessel, the vessel having an interior, the interior of the vessel containing:
a nuclear reactor core,
at least a molten salt primary heat exchange loop comprising a molten salt primary heat exchange medium pump for circulating a molten salt primary heat exchange medium in the primary heat exchange loop,
at least one sensor configured to provide a signal representative of an operation state of the nuclear reactor,
a primary heat exchanger, the primary heat exchange loop passes through the primary heat exchanger,
a breaker circuit arrangement comprising a circuit breaker, the breaker circuit arrangement being configured to connect and disconnect at least one of electric and/or electronic components in the interior to and from a source of electric power inside the vessel, the breaker circuit arrangement, comprising a circuit breaker having and open and a closed state, the breaker circuit arrangement being connected to the at least one sensor,
and the breaker circuit arrangement being configured to open a circuit breaker when the signal from the at least one sensor exceeds a safety threshold, preferably a safety threshold that indicates that the molten salt nuclear reactor is operated in an undo manner, a failure of a critical component has occurred, or another safety critical threshold has been exceeded.

According to a possible implementation form of the third aspect, the electric and/or electronic components comprise one or more of:
an electric motor driving the primary heat exchange medium pump,
an actuator of a normally closed valve in a fluid supply conduit of a fluid driven motor driving the primary heat exchange medium pump,
be an actuator of a normally open salt valve that allows the molten salt primary heat exchange medium to drain from the molten salt primary heat exchange loop when the normally open salt valve is open.

According to a possible implementation form of the third aspect, the at least one sensor comprises a sensor configured to sense a temperature of the primary heat exchange medium.

According to a possible implementation form of the third aspect, the nuclear reactor is configured to end the nuclear reaction and enter a safe state upon disconnecting the at least one of electric and/or electronic components in the interior from the source of electric power.

According to a possible implementation form of the third aspect, the nuclear reactor is configured to start operation when the electric and/or electronic components are connected to the source of electric power, preferably by switching the breaker circuit arrangement from an open position to a closed position.

According to a possible implementation form of the third aspect, the nuclear reactor is configured to end operation by disconnecting the electric and/or electronic components to the source of electric power, preferably by switching the breaker circuit arrangement from an open position to a closed position.

According to a possible implementation form of the third aspect, the breaker circuit arrangement comprises a circuit breaker and a controller, the controller comprising analog electronics and/or digital electronics that are configured to operate the circuit breaker as either open or closed.

According to a possible implementation form of the third aspect, at least one sensor comprises one or more of:
a fuel salt temperature sensor at a position between an outlet of the primary heat exchanger and a fuel salt inlet of the nuclear reactor core, a fuel salt temperature at a position between a fuel salt outlet of the nuclear reactor core and an inlet of the primary heat exchanger, a fuel salt flow rate sensor, the fuel salt flow rate preferably being derived from the rotation speed of the primary pump.

According to a possible implementation form of the third aspect, the breaker circuit arrangement is configured to require the safety threshold to be exceeded for a predetermined amount of time before switching a circuit breaker to the open position.

According to a possible implementation form of the third aspect, the breaker circuit arrangement is configured to use the first or second derivative of a signal from the at least one sensor, in addition, or instead of the value of the signal itself, for determining if a safety threshold has been exceeded.

According to a possible implementation form of the third aspect, the at least one sensor is arranged inside the interior.

According to a possible implementation form of the third aspect, the primary heat exchange medium pump is of an open type that is open for passage of the primary heat exchange medium when the primary pump is not operating, wherein the primary heat exchange loop is fluidically connected to a primary exchange medium drain tank and wherein the nuclear reactor is configured to allow the primary heat exchange medium to drain by the effect of gravity into the primary exchange medium drain tank when the primary pump is stopped, regardless of the cause of the primary pump being stopped, preferably without the need of any flow control elements, such as valves.

According to a possible implementation form of the third aspect, the primary heat exchange medium pump is a centrifugal type pump.

According to a possible implementation form of the third aspect, the primary heat exchange medium contains fissile material and the primary heat exchange medium drain tank is configured for passive decay heat removal.

According to a fourth aspect, there is provided a method of operating a molten salt nuclear reactor that maintains a sustained nuclear fission chain reaction, the nuclear reactor comprising a closed and preferably leaktight vessel, the vessel having an interior, the interior of the vessel containing:
a nuclear reactor core,
at least a molten salt primary heat exchange loop comprising a molten salt primary heat exchange medium pump for circulating a molten salt primary heat exchange medium in the primary heat exchange loop,
at least one sensor configured to provide a signal representative of an operation state of the nuclear reactor,
   a primary heat exchanger, the primary heat exchange loop passes through the primary heat exchanger, a breaker circuit arrangement comprising a circuit breaker, the breaker circuit arrangement being configured to connect and disconnect at least one of electric and/or electronic components in the interior to and from a source of electric power inside the vessel, the breaker circuit arrangement, comprising a circuit breaker having and open and a closed state, the breaker circuit arrangement being connected to the at least one sensor, the method comprising determining that the signal from the at least one sensor exceeds a safety threshold, preferably a safety threshold that indicates that the nuclear reactor is operated in an undo manner, a failure of a critical component has occurred, or another safety critical threshold has been exceeded, and opening a circuit breaker when it has been determined that the signal from the at least one sensor exceeds a safety threshold.

According to a possible implementation form of the fourth aspect, the method comprises allowing the primary heat exchange medium to drain from the primary heat exchange loop under the influence of gravity to a primary heat exchange medium drain tank arranged below the primary exchange loop when the circuit breaker is opened.

According to a possible implementation form of the fourth aspect, the primary heat exchange pump is stopped when the circuit breaker is opened and wherein the primary heat exchange medium is allowed to drain from the primary heat exchange loop under the influence of gravity, at least partially through the primary heat exchange pump.

According to a possible implementation form of the fourth aspect, wherein the at least one of electric and/or electronic components in the interior comprise:
an electric motor driving the primary heat exchange medium pump,
an actuator of a normally closed valve in a supply conduit of a fluid driven motor driving the primary heat exchange medium pump,
an actuator of a normally open salt valve that allows the molten salt primary heat exchange medium to drain from the molten salt primary heat exchange loop when the normally open salt valve is open.

These and other aspects will be apparent from the embodiments described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 is a diagrammatic representation of a first embodiment of a nuclear reactor connected to a consumer of heat,

FIG. 2 is a diagrammatic representation of a second embodiment of a nuclear reactor connected to the consumer of heat,

FIG. 3 is a diagrammatic representation of a third embodiment of a nuclear reactor connected to the consumer of heat,

FIG. 4 is a diagrammatic representation of a fourth embodiment of a nuclear reactor of a molten salt type,

FIG. 5 is a diagrammatic representation of a fifth embodiment of a nuclear reactor of a molten salt type,

FIG. 6 is a diagrammatic representation of a sixth embodiment of a nuclear reactor of a molten salt type, and

FIG. 7 is a diagrammatic representation of a seventh embodiment of a nuclear reactor of a molten salt type.

### DETAILED DESCRIPTION

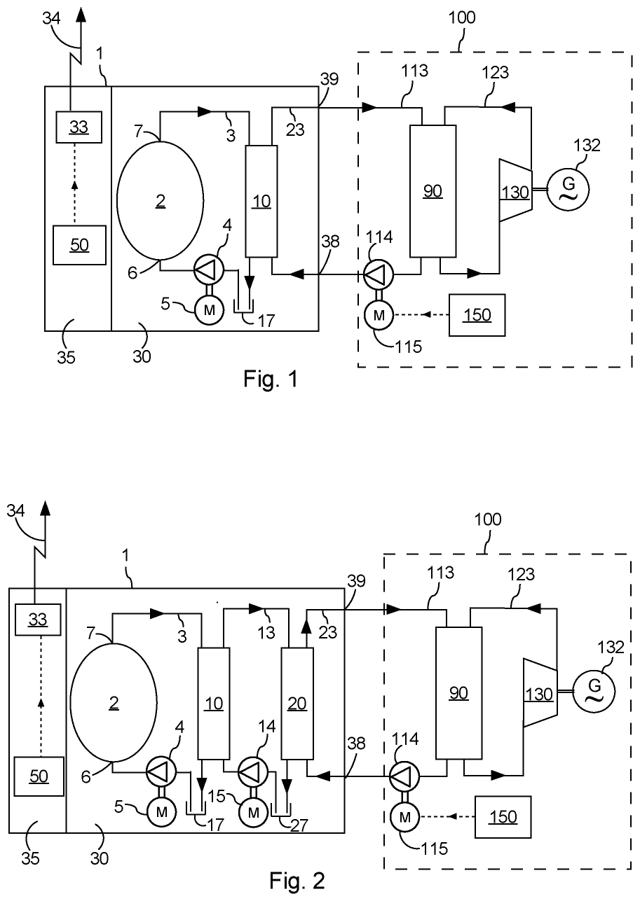

FIG. 1 illustrates a first embodiment of a nuclear reactor 1. The nuclear reactor is arranged in the interior of a hermetically sealed vessel 1, also referred to as “reactor vessel”. The hermetically sealed vessel 1 forms an airtight housing in which the components of the nuclear reactor are located. In an embodiment, the reactor vessel 1 is a metal, preferably steel, casing, e.g. a casing with metal or steel walls. In an embodiment, the reactor vessel 1 is provided with two or more layers of airtightness, i.e. double, triple, etc. walled vessel, the third barrier e.g. serving in particular radiation protection (not illustrated in FIG. 1).

The interior of the reactor vessel 1 is optionally divided into a hot area 30, sometimes referred to as “furnace”, and a cool area 35. The interior of the vessel 1 contains a nuclear reactor core 2, preferably in the hot area 30, and a primary heat exchange loop 3, for transporting heat away from the nuclear reactor core 2, preferably also in the hot area 30 by circulating a primary heat exchange medium. Temperature-sensitive equipment, such as electrical power supply systems and electronics, e.g. controller 50, uplink transmitter 33 are as far as possible arranged in the cool area 35.

The nuclear reactor is one or more of the following types of reactors (nonexhaustive list), pressurized water reactor, boiling water reactor, pressurized heavy water reactor, gas-cooled reactor, molten salt reactor, fast neutron reactor. The primary heat exchange medium is determined by the reactor type and can be one or more of the following (nonexhaustive list), water, heavy water, helium, carbon dioxide, sodium, molten salt (fluoride or chloride salt), lead or lead-bismuth eutectic. depending on the type of reactor, the primary heat exchange medium not only serves to remove heat from the reactor but has additional functions, e.g. acting as moderator or containing the nuclear fuel.

During the operation of the nuclear reactor, a sustained nuclear-controlled chain reaction takes place in the nuclear reactor core 2. Active and passive control of the sustained chain reaction involves adjusting the level of fission-inducing neutrons in the reactor core 2, and the way in which this is achieved may depend on the reactor type. In some types of reactors adjusting the level of fission-inducing neutrons in the reactor core 2 involves movement of control rods made of highly neutron absorbing material and therefore absorb neutrons. One or more control rods (not shown) are inserted deeper into the nuclear reactor core 2, to absorb more neutrons than the material or medium it displaces. This action results in fewer neutrons available to cause fission and reduces the power output of the nuclear reactor. Conversely, extracting one or more control rods will result in an increase in the rate of fission events and an increase in power output of the nuclear reactor. In other types of nuclear reactors, adjusting the level of fission-inducing neutrons in the nuclear reactor core 2 involves adjusting the temperature or the amount of moderator present in the nuclear reactor core 2. In case of a liquid moderator, the temperature of the liquid moderator is decreased resulting in a higher density of the liquid moderator or the level or amount of liquid moderator in the nuclear reactor core 2 is increased to increase the level of fission-inducing neutrons in the reactor core 2 by causing a larger proportion of fast neutrons that are released from fission to lose energy and become thermal neutrons that are more likely than fast neutrons to cause fission or less likely to leak out of the reactor core 2, and vice versa.

In the embodiment of FIG. 1 the nuclear reactor is a molten salt reactor, by way of example. In this embodiment, the primary heat exchange loop 3 comprises a primary pump 4 for circulating the primary heat exchange medium in the primary heat exchange loop 3. The primary pump 4 is a circulation pump that is driven by a primary motor 5, which is preferably an electric drive motor provided with a motor drive for adjusting the speed of the electric motor 5. Heaters (not shown), e.g. electric heaters are provided for each heat exchange loop that contains a heat exchange medium that is solid at normal room or environment temperatures, to allow the medium to warm up to the liquid phase so that the heating medium can be pumped.

The primary heat exchange loop 3 extends through the nuclear reactor core 2, and accordingly, the nuclear reactor core 2 is provided with a primary heat exchange medium inlet 6 and a primary heat exchange medium outlet 7 that connect the portion of the primary heat exchange loop 3 that extends through the nuclear reactor core 2. The primary heat exchange loop 3 passes through a primary heat exchanger 10 for exchanging heat with an internal as well as external heat change medium and through the primary heat exchange medium tank 17 which forms the lowest part of the primary heat exchange loop 3. The primary pump 4 pumps the primary heat exchange medium up from the primary exchange medium drain tank 17. The primary pump 4 is driven by a primary electric motor 5 and the primary pump 4 is of an open type, e.g. a centrifugal type pump that is open for passage of primary heat exchange medium when the primary pump 4 is not operating (stopped). Thus, the primary heat exchange medium will drain by the effect of gravity into the primary exchange medium drain tank 17 when the primary pump 4 is stopped, regardless of the cause of the primary pump 4 being stopped, without the need for any flow control elements, such as valves or pumps to ensure passive safety. The primary heat exchange medium drain tank 17 is configured for passive decay heat removal, the drain tank preferably comprises passive cooling means for removing heat from the drain tank 17, e.g. conductive heat transfer through the bottom of the tank or from a cooling medium passing though the tanks and driven by buoyancy to achieve passive convective cooling.

A conduit 23 for removing heat from the interior of the reactor vessel 1 is arranged in the interior of the reactor vessel 1. An internal as well as external heat exchange medium flows through the conduit 23. In an embodiment, the internal as well as external heat exchange medium is a molten nitrate salt, but it could also be another type of salt, or another type of suitable liquid, gas, or vapor. The internal as well as external heat exchange medium is pumped through the internal as well as external heat exchange medium conduit 23, which passes through the first heat exchanger 10 to remove heat produced from the primary heat exchange medium and convey this heat to a consumer of heat 100. The conduit 23 fluidically connects an inlet 38 with an outlet 39. Both the inlet 38 and the outlet 39 penetrate the walls of the vessel 1 for connecting to an exterior consumer of heat 100.

The consumer of heat 100 is arranged exterior to reactor vessel 1 and fluidically connected to the reactor vessel 1 at the heat exchange medium inlet port 38 and at the heat exchange outlet port 39, and the consumer of heat does not form part of the nuclear reactor. In this example, the consumer of heat 100 comprises an external conduit 113, which together with the heat exchange conduit 23 forms an internal as well as external heat exchange liquid loop that passes through an external heat exchanger 90. The external conduit 113 is fluidically connected to both the inlet port 38 and at the outlet port 39. An external pump 114 driven by an external electric motor 115 forces a circulating flow of internal as well as external heat exchange medium through the internal as well as external heat exchange loop. An external controller 150 adjusts the speed of the external pump 114 to control the amount of heat that is absorbed by the internal as well as external heat exchange medium, and thus, to control the amount of heat that is transported out of the nuclear reactor. The external heat exchanger 90 is in this example a boiler configured to exchange heat with a steam loop 123 that in turn is connected to a steam turbine 130 driving an alternator 132 to generate electric power. However, it is understood that the heat that is received by the customer of heat 100 could be used for any other purpose, i.e. any process that requires heat, e.g. industrial processes, district heating, or desalination, and that the electricity, besides being supplied to an electric grid, can be used for industrial purposes such as hydrogen production, hydrogen production for ammonia production, and metal refinement and/or recycling.

A number of sensors are provided in the interior of the vessel 1 to provide data originating inside the vessel data relating to the operation of the nuclear reactor.

At least the primary exchange loop 3 is provided with temperature sensors, for example in the form of thermocouples (not shown in FIG. 1), for sensing the temperature of the primary exchange medium. The temperature sensors generate a signal representative of the temperature that is sensed. For temperatures that are critical information, there will be two or more sensors for providing redundancy. In an embodiment, the temperature sensors are arranged in a thermowell (thermocouple well) or mounted on the pipe surface (of the pipe transporting/containing medium for which the temperature is to be sensed).

In an embodiment, a first and second temperature sensor (not shown), two sensors for redundancy reasons, are arranged at primary exchange loop 3 (between the primary heat exchange medium outlet 7, and the primary exchange medium inlet of the secondary heat exchanger 20) for sensing the temperature of the primary exchange medium leaving the reactor core 2. A second temperature sensor is arranged at the primary exchange loop 3 between the primary heat exchange medium outlet of the secondary heat exchanger 20 and the primary heat exchange medium inlet 6 for sensing the temperature of the primary exchange medium that is supplied to the reactor core 2.

Additional sensors that are arranged in the interior of the vessel 1 can be one or more of, radiation sensor, pressure sensor, vibration sensor, sound sensor, light sensor, camera sensor, flow rate sensor for sensing the flow rate of the liquid in any of the heat exchange loops or in a moderator loop (flow meter (e.g. turbine flow meter, venturi flow meter, elbow flow meter, ultrasonic flow meter) or pump speed sensor), pressure sensor for sensing pressure in any of the heat exchange loops or in a moderator loop, liquid composition sensor (e.g. electrochemical sensor, laser induced breakdown spectrometry sensor, Rayman spectrometry sensor) for sensing the composition of the liquid in any of the heat exchange loops or moderator loop, gas composition sensor, gas leak detection sensor, liquid leak detection sensor, seismic sensor, tilt sensor, door switch sensor, electromagnetic pulse sensor, and geolocation sensor,

A controller 50 is arranged in the interior of the reactor vessel 1 preferably as far as possible in the cool area 35. The controller 50 is in an embodiment a distributed controller. The controller 50 does not receive any signals from the exterior of the reactor vessel 1, and operates/relies on the basis of data that is generated inside the reactor vessel 1, preferably exclusively on the basis of data that is generated inside the reactor vessel 1. The data that is generated inside the reactor vessel 1 originates, at least in part, from sensors that are arranged inside the reactor vessel 1. The controller 50 is in receipt of a signal of one or more sensors that are arranged inside the reactor vessel 1.

The controller 50 is configured to autonomously control the operation of the nuclear reactor, relying preferably exclusively on data that has originated from within the reactor vessel 1. The data originating from within the vessel 1 preferably comprises at least one thermodynamic condition of the primary heat exchange medium.

The controller 50 is configured to control power output of the nuclear reactor core 2 by adjusting the sustained nuclear fission chain reaction, by adjusting the level of fission-inducing neutrons in the reactor core 2. The controller 50 is configured to control the power output of the nuclear reactor by adjusting the amount of heat produced by the nuclear reactor to the amount of heat removed from the nuclear reactor by the internal as well as external heat exchange medium by controlling the nuclear chain reaction. The controller 50 is configured to control the nuclear chain reaction by adjusting the speed of the primary pump 4 by controlling the electric power delivered to the primary electric motor 5. In a molten salt reactor, adjusting the flow rate of the primary coolant indirectly influences the reactivity, assuming that the coolant temperature remains constant.

The controller 50 is configured to maintain the operating parameters of the nuclear reactor within a specified range or ranges, thereby allowing for the heat generated by the nuclear reactor core 2, at least during normal operation of the nuclear reactor, to be transferred by the internal as well as external heat exchange medium in the primary heat exchanger 10 and allows the nuclear fission chain reaction in the nuclear reactor to be regulated.

The controller 50 is configured to control the power output of the nuclear reactor core 2 as a function of the power being absorbed by the internal as well as external heat exchange medium in the heat exchanging arrangement, the function is preferably a function that ensures that the power output of the nuclear reactor core 2 is substantially equal to the power absorbed by the internal as well as external heat exchange medium in the heat exchanger 10.

The controller 50 is preferably configured to adjust the speed of the primary pump 4 as a function of the at least one thermodynamic condition of the primary heat exchange medium. The at least one thermodynamic condition preferably originates from one or more of the sensors arranged inside the vessel 1, e.g. a temperature sensor configured for sensing the temperature of the primary heat exchange medium, the function preferably comprising one or more of a proportional component, an integral component, a differential component, and/or the at least one controller 50 comprising a Model Predictive Controller.

The at least one thermodynamic condition of the primary heat exchange medium may comprise a temperature or a derivative thereof of the primary heat exchange medium sensed by a temperature sensor that is arranged in the interior.

The controller 50 is configured to maintain the temperature of the primary heat exchange medium at a specified temperature or within a specified temperature range as specified below. Preferably, the controller 50 is configured to adjust the primary pump speed to keep the fuel salt temperature at the fuel salt outlet 7 to approximately 700° C., preferably comprising decreasing primary pump speed to increase the fuel salt temperature at the fuel salt outlet 7, and increasing primary pump speed to decrease the fuel salt temperature at the fuel salt outlet 7.

The one controller 50 comprises one or more of: analog electronics, digital electronics, software for processing electronics values, mechanical logic, hydraulic and/or fluidic logic. The controller 50 preferably does not comprise an electronic digital programmable computer and preferably uses a redundant architecture, even more preferably a dissimilar redundant architecture.

The controller 50 can optionally be coupled to a transmitter 33 that is configured to send an uplink signal to a remote receiver, such as a remote server, thereby allowing the operation of the nuclear reactor to be remotely monitored. However, the transmitter 33 is as the name says only capable of transmitting data and is not capable of receiving data. Hereto, the controller is configured to send relevant data concerning the operation of the nuclear reactor to the transmitter 33.

In an embodiment the controller 50 uses an ‘air-gapped’ transmission to transmit data to a receiver outside the reactor vessel 1, to ensure that no data or instruction can be received by the controller 50 and to protect against an attacker trying to spoof the data uplink to gain access or control over the controller 50. Air-gapping is a security measure that involves isolating the controller 50 and preventing it from establishing an external connection. Thus, the controller 50 is physically segregated and incapable of connecting wirelessly or physically with other computers or network devices.

The consumer of heat 100 (or a human operator) can shut the reactor down by cutting off the supply of electric power 53 to the electric and electronic components in the reactor vessel 1, mainly as an emergency shutdown. Thereupon, the primary, secondary, and other heat exchange media will automatically drain to their respective drain tanks.

Alternatively, the consumer of heat 100 can shut the reactor down by stopping or ramping down the flow rate of the inside as well as outside heat exchange medium through conduit 23 to stop the reactor from producing heat. When the power requirement from the consumer of heat 100 drops below the decay heat produced during normal maximum operation (typically ˜5% of full power) the reactor will shut down to dispose of decay heat. Consequently, if the consumer of heat 100 ramps down to a consumption that is below the decay heat the reactor will stop the pumps 4,14,44 because not enough heat can be removed by the inside as well as outside heat exchange medium, and at least one of the salt (heat exchange medium) outlet temperatures will exceed their respective threshold. This is expected to be the most common way the consumer of heat 100 shuts down the reactor. This process will take several hours and may be initiated by the consumer of heat 100 e.g. for maintenance of the steam turbine 130,132.

The primary loop 3 is not pressurized, i.e. it operates with the primary heat exchange medium at substantially atmospheric pressure.

When at least one or a combination of the reactor parameters, e.g. in the form of thermodynamic conditions differs from the acceptable operating values or ranges (that are stored in advance and that the controller 50 has access to), the controller 50 will autonomously stop reactor operation. In some embodiments, the controller 50 will automatically stop the reactor operation by allowing the liquid to drain into the drain tank (17,48) under the influence of gravity. Examples of one or combination of reactor parameters differing from the acceptable operating values or ranges are the flow rate in the primary loop 3 being above an acceptable value or the fluid pressure in the primary loop or any other part of the system being in excess of an acceptable value. Other examples of one or a combination of reactor parameters differing from acceptable operating values are provided below.

FIG. 2 shows a second embodiment of the nuclear reactor. In this embodiment, structures, and features that are the same or similar to corresponding structures and features previously described or shown herein are denoted by the same reference numeral as previously used for simplicity. In this embodiment, the nuclear reactor comprises a secondary coolant loop 13 that is arranged inside the vessel 1. The secondary coolant loop passes through the primary heat exchanger 10 and exchanges heat with the internal as well as external heat exchange medium in a secondary heat exchanger 20. In this embodiment, the secondary heat exchange loop 13 comprises a secondary pump 14 for circulating a secondary heat exchange medium in the secondary heat exchange loop 13. The secondary pump 14 is a circulation pump that is driven by a secondary motor 15, which is preferably an electric motor. The secondary pump 14 is of an open type, e.g. a centrifugal type pump that is open for passage of primary heat exchange medium when the primary pump 14 is not operating (stopped). Thus, the secondary heat exchange medium will drain by the effect of gravity into the secondary exchange medium drain tank 27 when the secondary pump 14 is stopped, regardless of the cause of the secondary pump 14 being stopped, without the need for any flow control elements, such as valves or pumps to ensure passive safety. The secondary loop 23 is not pressurized, i.e. the secondary heat exchange medium is operated at a second substantially atmospheric pressure.

In this embodiment, the controller 50 is configured to regulate the speed of the secondary pump 14, with the primary aim to keep the temperature of the secondary heat exchange medium within a predetermined bandwidth or close to a predetermined set point. Preferably, the controller 50 is configured to adjusting secondary pump speed by adjusting the power to the secondary pump motor 15 to keep the fuel salt temperature at the fuel salt inlet 6 to approximately 600° C., preferably comprising increasing the secondary pump speed to decrease the temperature of the fuel salt at the fuel salt inlet 6 and decreasing secondary pump speed to increase the temperature of the fuel salt at the fuel salt inlet 6.

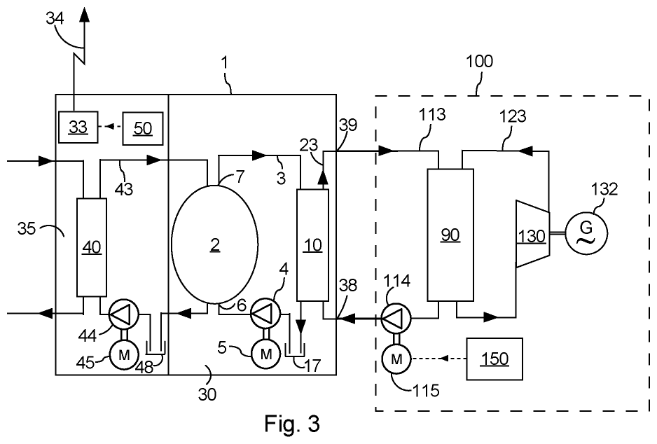

FIG. 3 shows a third embodiment of the nuclear reactor. In this embodiment, structures, and features that are the same or similar to corresponding structures and features previously described or shown herein are denoted by the same reference numeral as previously used for simplicity. In this embodiment, the nuclear reactor interior contains a liquid moderator loop 43. The liquid moderator loop 43 comprises a moderator pump 44 for circulating the liquid moderator in the moderator loop 43. The liquid moderator loop 43 passes through the nuclear reactor core 2, and preferably passes through a liquid moderator heat exchanger 40. The liquid moderator heat exchanger 40 exchanges heat with an inside as well as outside cooling medium, which is circulated through the liquid moderator heat exchanger and through a cooler (not shown) that is arranged exterior to the vessel 1.

In this embodiment the at least one at least one thermodynamic condition preferably comprises one or more of:
liquid moderator temperature at a position between a liquid moderator outlet of the liquid moderator heat exchanger 40 and a liquid moderator inlet of the nuclear reactor core 2,
liquid moderator temperature at a position between a liquid moderator outlet of the nuclear reactor core 2, and a liquid moderator inlet of the liquid moderator heat exchanger 40,
liquid moderator flow rate, the liquid moderator flow rate preferably being derived from the rotation speed of the tertiary pump 44.

The liquid moderator loop 43 is not pressurized, i.e. the liquid moderator is operated at a second substantially atmospheric pressure.

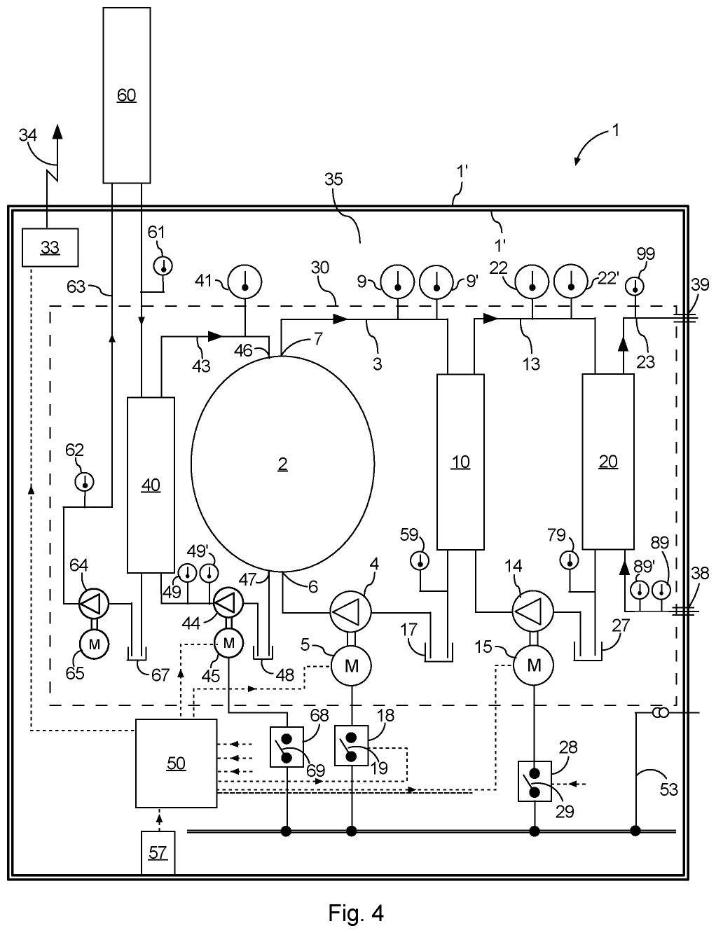

FIG. 4 illustrates a fourth embodiment in which the nuclear reactor is a molten salt nuclear reactor. In this embodiment, structures and features that are the same or similar to corresponding structures and features previously described or shown herein are denoted by the same reference numeral as previously used for simplicity. The molten salt nuclear reactor is arranged in the interior of a hermetically sealed vessel 1, also referred to as “reactor vessel”. The hermetically sealed vessel 1 forms an airtight housing in which the components of the molten salt nuclear reactor are located. In an embodiment, the reactor vessel 1 is a metal, preferably steel casing, i.e. a casing with metal or steel walls. In an embodiment, the reactor vessel 1 is provided with two layers of airtightness, i.e. double walled vessel, as illustrated by the reactor vessel 1 having an inner wall 1′ surrounded by an outer wall 1″ in FIG. 1.

The interior of the reactor vessel 1 is in an embodiment divided into a hot area 30, sometimes referred to as furnace, and a cool area 35. The interior of the vessel 1 contains a nuclear reactor core 2, preferably in the hot area 30, and at least one salt loop 3, 13, preferably in the hot area 30. In the present embodiment, a liquid moderator loop 43 is contained in the interior of the vessel 1, preferably in the hot area.

The nuclear reactor will have at least a fuel salt loop 3 (primary loop), and optionally one or more cooling salt loops 13 (secondary and tertiary loops). Each salt loop 3, 13 comprises a pump 4, 14 for circulating a molten salt in the salt loop 3, 13 concerned. Each salt loop 3, 13 contains a molten salt or a molten salt mixture with suitable properties, e.g. a fluoride or chloride salt. An example of a suitable salt for the molten salt loop is FLiBe (a mixture of lithium fluoride (LiF) and beryllium fluoride (BeF2).

The fuel salt loop 3 extends through the nuclear reactor core 2, and accordingly, the nuclear reactor core 2 is provided with a fuel salt inlet 6 and a fuel salt outlet 7 that connect the portion of the fuel salt loop 3 that extends through the nuclear reactor core 2. The fuel salt comprises fissile components, preferably comprising enriched lithium 7 fluoride, thorium tetrafluoride, uranium tetrafluoride, uranium trifluoride and/or plutonium trifluoride 7LiF—ThF4—UF4—UF3—PuF3 salt. The fuel salt loop 3 passes through a first heat exchanger 10 for exchanging heat with the primary coolant salt and through a fuel salt drain tank 17 which forms the lowest part of the fuel salt loop 3. The fuel salt pump 4 pumps the fuel salt up from the fuel salt drain tank 17. The fuel salt pump 4 is driven by a primary electric motor 5 and the fuel salt pump 4 is of an open type, e.g. a centrifugal type pump that is open for passage of the fuel salt when the fuel salt pump 4 is not operating. Thus, the fuel salt drains by the effect of gravity into the fuel salt drain tank 17 when the fuel salt pump 4 is stopped, without the need for any flow control elements, such as valves or pumps.

One of the optional cooling salt loops, is a primary cooling salt loop 13, which extends through the first heat exchanger 10 for exchanging heat with the fuel salt, through a second heat exchanger 20 for exchanging heat with an internal as well as external heat exchange medium and through a primary cooling salt drain tank 27 that forms the lowest part of the primary cooling salt loop 13. The primary cooling salt pump 14 pumps the primary cooling salt up from the primary cooling salt drain tank 27. The primary cooling salt pump 14 is driven by a secondary electric motor 15 and the primary cooling salt pump 14 is of an open type, e.g. a centrifugal type pump that is open for passage of the primary cooling salt when the primary cooling salt pump 14 is not operating. Thus, the fuel salt drains by the effect of gravity into the primary cooling salt drain tank 27 when the primary cooling salt pump 14 is stopped, without the need for any flow control elements, such as valves or pumps. The primary cooling salt loop 13 is not pressurized, i.e. the primary cooling salt is operated at substantially atmospheric pressure.

A liquid moderator loop 43 extends through the nuclear reactor core 2, and accordingly, the nuclear reactor core 2 is provided with a liquid moderator inlet 46 and a liquid moderator outlet 47 that connect the portion of the liquid moderator loop 43 that extends through the nuclear reactor core 2. The liquid moderator loop 43 comprises a moderator pump 44 for circulating the liquid moderator in the moderator loop 43. The liquid moderator comprises in an embodiment heavy water or a molten hydroxide, preferably molten enriched lithium 7 deuteroxide salt (7LiOD). The liquid moderator loop passes through a liquid third heat exchanger 40 for the liquid moderator to exchange heat with a liquid moderator cooling medium. The liquid moderator loop 43 extends through a liquid moderator drain tank 48 that forms the lowest part of the liquid loop 43. The tertiary pump 44 pumps the liquid moderator up from the liquid moderator drain tank 48. The tertiary pump 44 is a circulation pump driven by a tertiary electric motor 45 and is of an open type, e.g. a centrifugal type pump that is open for passage of the liquid moderator salt when the tertiary 44 is not operating. Thus, the liquid moderator by the effect of gravity into the liquid moderator drain tank 48 when the tertiary pump 44 is stopped, without the need for any flow control elements, such as valves or pumps. The tertiary pump is driven by a tertiary electric motor 45.

The liquid moderator cooling medium circulates in a liquid moderator cooling medium loop 63. The liquid moderator cooling medium loop 63 comprises a liquid moderator cooling medium pump 64 driven by a quaternary electric motor 65 for circulating the liquid moderator, a liquid moderator cooling medium drain tank 67 and a liquid moderator cooling medium cooler 60. The liquid moderator cooler 60 is preferably arranged outside the reactor vessel 1. The liquid moderator cooling medium drain tank 67 forms the lowest part of the liquid moderator cooling medium loop 63. The liquid moderator cooling medium pump 64 is a circulation pump that is driven by quaternary motor 65 and the liquid moderator cooling medium pump 64 is of an open type, e.g. a centrifugal type pump that is open for passage of the liquid moderato when the liquid moderator cooling medium pump 64 is not operating. Thus, the liquid moderator cooling medium drains by the effect of gravity into the liquid moderator drain tank 48 when the liquid moderator cooling medium pump 64 is stopped, without the need of any flow control elements, such as valves or pumps.

A heat exchange medium conduit 23 for removing heat from the interior of the reactor vessel 1 is arranged in the interior of the reactor vessel 1. An internal as well as external heat exchange medium is flowed through the conduit 23 for exchanging heat in the second heat exchanger 20 with the primary cooling salt. In an embodiment, the internal as well as external heat exchange medium is a molten nitrate salt, but it could also be another type of salt, or another type of suitable liquid or gas, or vapor. The internal as well as external heat exchange medium is pumped through the heat exchange medium conduit 23 and thus through the second heat exchanger 20 to remove the heat produced in the fuel salt and convey this heat to a consumer of heat. The internal as well as external heat exchange medium conduit 23 fluidically connects a heat exchange medium inlet 38 with a heat exchange medium outlet 39. Both the heat exchange medium inlet 38 and the heat exchange medium outlet 39 open to the exterior of the vessel 1 for connecting to an exterior consumer of heat as described with reference to FIGS. 1 to 3 above.

The fuel salt loop 3 is provided with a temperature sensor 9 for sensing the temperature of the fuel salt leaving the reactor core 2, together with a second temperature sensor 9′ for redundancy. The signal of the sensors 9,9′ is communicated to the controller 50. The fuel salt loop 3 can also be provided with a temperature sensor 59 for sensing the temperature of the fuel salt going into the reactor core 2. The signal of the sensor is communicated to the controller 50.

The cooling salt loop 13 is provided with a temperature sensor 22 for sensing the temperature of the cooling salt leaving the first heat exchanger 10, together with a second temperature sensor 22′ for redundancy. The signal of the sensors is communicated to the controller 50. The cooling salt loop 23 can also be provided with a temperature sensor 79 for sensing the temperature of the cooling salt going into the first heat exchanger 10. The signal of the sensor is communicated to the controller 50.

Similarly, the moderator loop is provided with a pair of temperature sensors 49, 49′ for sensing the temperature of the liquid moderator leaving the reactor core 2, and with another temperature sensor 41 for sensing the temperature of the liquid moderator going into the reactor core 2. The signal of the sensors is communicated to the controller 50.

The liquid moderator cooling loop is provided with a temperature sensor 62 for sensing the temperature of the moderator cooling medium leaving the liquid moderator heat exchanger 40 and with a temperature sensor 61 for sensing the temperature of the liquid moderator cooling medium entering the liquid moderator heat exchanger 40.

The conduit 23 for the inside as well as outside the exchange medium is provided with a pair of temperature sensors 89, 89′ for sensing the temperature of the internal as well as external heat exchange medium entering the conduit 23 through the inlet opening 38 and with a temperature sensor 99 for sensing the temperature of the inside as well as outside heat exchange medium leaving the conduit through outlet 39.

The above-mentioned temperature sensors can e.g. be implemented in the form of thermocouples or thermo-switch. If the temperature sensor is a thermocouple it generates a signal representative of the temperature that is sensed. For temperatures that are critical information, there will be two or more sensors for providing redundancy. If the temperature sensor is a thermo-switch it generates either a closed or open circuit, that can have a predetermined and hardwired temperature at which forms an open circuit that can e.g. be used to trip a breaker circuit. The thermo-switch can e.g. use a bimetallic strip or differential thermal expansion to trigger when a threshold temperature is reached with high reliability.

In an embodiment, a seismic sensor 57 is arranged in the interior 30,35 of the reactor vessel 1. the signal of the seismic sensor 57 is communicated to the controller 50, to allow the controller 50 to safely shut down the operation of the nuclear reactor when seismic events that exceed a predetermined level are sensed by the sensor 57.

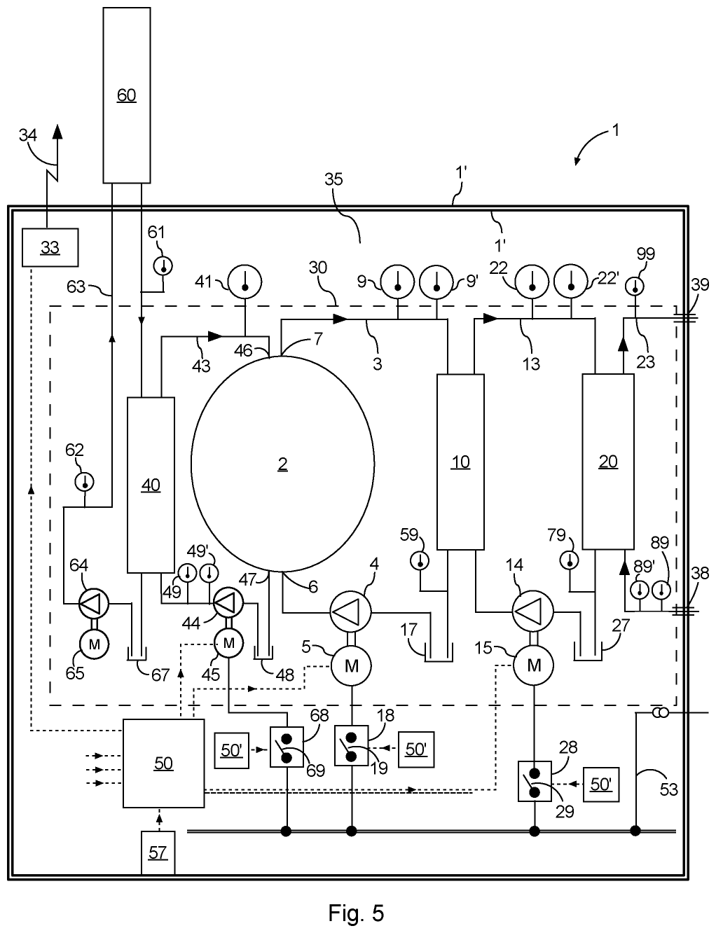

FIG. 5 shows a fifth embodiment of the nuclear reactor. In this embodiment, structures, and features that are the same or similar to corresponding structures and features previously described or shown herein are denoted by the same reference numeral as previously used for simplicity. This embodiment is essentially identical to the embodiment of FIG. 4, except that the circuit breaker arrangements 19,29,69 have a dedicated controller 50′, and the controller 50 is not used to control the circuit breaker arrangements 16,29,69.

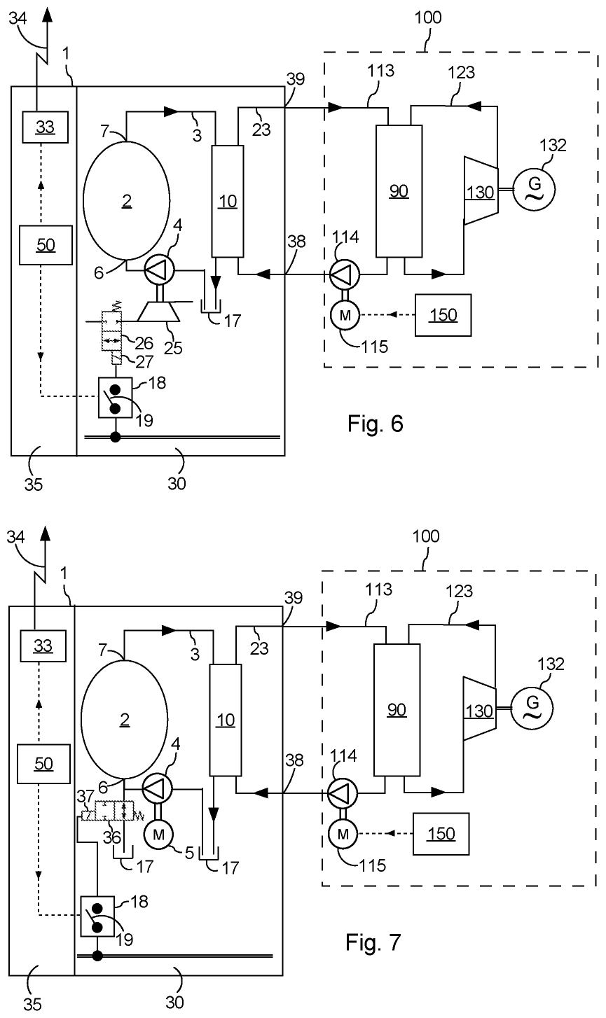

FIG. 6 shows a sixth embodiment of the nuclear reactor. In this embodiment, structures, and features that are the same or similar to corresponding structures and features previously described or shown herein are denoted by the same reference numeral as previously used for simplicity. This embodiment, is essentially identical to the embodiment of FIG. 1, except that the primary pump 4 is driven by a turbine 25 (e.g. a steam turbine) or other fluidically driven motor, and a breaker circuit arrangement 18 comprising a circuit breaker 19 is operably connected to a normally closed valve 26. The normally closed valve 26 is arranged in a fluid (steam) supply conduit that supplies the turbine 25 with fluidic power (hydraulic or pneumatic or steam power) and the normally closed valve 26 is moved to its open position (in which the normally closed valve 26 allows fluidic power to the turbine 25) by an electric actuator (e.g. solenoid) 27 and moves to its closed position (where the normally closed valve 26 does not allow fluidic power to the turbine 25) by e.g. a resilient element. The circuit breaker arrangement 28 is connected to the controller 50 and configured to trip the circuit breaker 19 upon receiving this signal to do so from the controller 50. Thus, when the circuit breaker 29 is tripped (to its open position), the electronic actuator is no longer powered and the normally closed valve 26 closes under the influence of the resilient element and the turbine 25 does not receive fluid power, and the primary pump 4 stops. This will allow the primary heat exchange medium to drain to the drain tank 17 and the nuclear reaction in the core 2 stops.

FIG. 7 shows a seventh embodiment of the nuclear reactor. In this embodiment, structures, and features that are the same or similar to corresponding structures and features previously described or shown herein are denoted by the same reference numeral as previously used for simplicity. This embodiment is essentially identical to the embodiment of FIG. 1, except that the primary heat exchange circuit 3 is connected at a suitable (i.e. relatively low) position to a drain conduit that leads to the drain tank 17. A normally open valve 36 is arranged in the drain conduit. The normally open valve 36 is moved to its closed position by an electric actuator (e.g. a solenoid) 37 and the normally open valve 36 moves to its open position (e.g. under the influence of a resilient element) when the electric actuator 37 is not powered. The electric actuator 37 receives electric power through a circuit breaker arrangement 18 that comprises a circuit breaker 19. The circuit breaker arrangement 18 is connected to the controller 50 and the circuit breaker arrangement 18 is configured to trip the circuit breaker 19 to its open position upon receiving a signal to do so from the controller 50. Thus, when the circuit breaker arrangement 18 receives a signal from the controller 50 to stop the operation of the nuclear reactor 1, the circuit breaker 19 is tripped to its open position, thereby cutting off electric power to the electric actuator 37, which causes the normally open valve 36 to move to its open position, thereby allowing the primary heat exchange medium to drain from the primary exchange circuit 3 to the train tank 17, which causes the nuclear reaction in the nuclear reactor core 2 to stop.

In an embodiment, a radiation level sensor (not shown) for generating a signal representative of a radiation level in the interior of the reactor vessel 1 is arranged in the interior of the reactor vessel 1.

In an embodiment, a sensor is configured for issuing a signal indicative of the open and/or closed position of a door (not shown) in the reactor vessel 1 for giving access to the interior (30,35).

In an embodiment, one or more of the salt loops 3, 13, the moderator loop 43, and the heat exchange conduit 23 are provided with a leak sensor (not shown) configured to issue a leak signal when a leak occurs.

The controller 50 is arranged in the interior of the reactor vessel 1, preferably in the cool area 35. The controller 50 is in an embodiment a distributed controller, i.e. it is composed of several interconnected controllers that can be physically arranged in different locations. The controller 50 does not receive any data or signals from the exterior of the reactor vessel 1 and operates/relies preferably exclusively on the basis of data that is generated inside the reactor vessel 1. The data that is generated inside the reactor vessel 1 originates, at least in part, from sensors that are arranged inside the reactor vessel 1. The controller 50 is in receipt of a signal from the sensors that are arranged inside the reactor vessel 1.

The controller 50 is configured to control the speed of the primary, secondary, tertiary, and quaternary electric motor 5, 15, 45, 65 through a signal to the drive associated with the respective electric motor. The controller 50 is also configured to start and end the operation of the primary, secondary, tertiary, and quaternary pumps, 5, 15, 45, 65.

Additionally, the controller 50 can be configured to control the secondary, tertiary, and quaternary electric motors 15, 45, 65 for adjusting the speed of the secondary pump 14, the tertiary pump 44, and the tertiary pump 65. The controller 50 is also configured to start and end the operation of the primary, secondary, tertiary, and quaternary pumps, 5, 15, 45, 65.

The fuel salt loop 3 provides fuel salt to the reactor core 2 for driving and controlling the nuclear reaction. The optional moderator loop provides liquid moderator to the reactor core 2 for controlling the nuclear reaction.

The controller 50 is configured to autonomously control the operation of the nuclear reactor relying preferably exclusively on data originating inside the vessel 1. At least some of the data originating inside the vessel 1 originate from one or more sensors arranged inside the vessel 1. The data originating from within the vessel 1 preferably comprises at least one thermodynamic condition of the primary heat exchange medium.

The at least one thermodynamic condition may comprise one or more of:
fuel salt temperature or a derivative thereof at a position between an outlet of the primary heat exchanger 10 and a fuel salt inlet 6 of the nuclear reactor core 2, fuel salt temperature or a derivative thereof at a position between a fuel salt outlet 7 of the nuclear reactor core 2 and an inlet of the primary heat exchanger 10,
fuel salt flow rate, the fuel salt flow rate preferably being derived from the rotation speed of the primary pump 4,
primary cooling salt temperature or a derivative thereof at a position between an outlet of the secondary heat exchanger 20 and a primary cooling salt inlet of the primary heat exchanger 10,
primary cooling salt temperature or a derivative thereof at a position between a primary cooling salt outlet of the primary heat exchanger 10 and an inlet of the secondary heat exchanger 20,
primary cooling salt flow rate, the primary cooling salt flow rate preferably being derived from the rotation speed of the secondary pump 14,
liquid moderator temperature at a position between a liquid moderator outlet of the liquid moderator heat exchanger 40 and a liquid moderator inlet of the nuclear reactor core 2,
liquid moderator temperature at a position between a liquid moderator outlet of the nuclear reactor core 2, and a liquid moderator inlet of the liquid moderator heat exchanger 40,
liquid moderator flow rate, the liquid moderator flow rate preferably being derived from the rotation speed of the tertiary pump 44.

The controller 50 is configured to provide an output value, the output value comprising one or more of:
speed of the primary pump 4,
speed of a secondary pump 14,
speed of a tertiary pump 44,
speed of a quaternary pump 64,
speed of a blanket salt pump,
ending operation of the primary pump 4,
ending operation of a secondary pump 14,
ending operation of a tertiary pump 44,
ending operation of a quaternary pump 64,
ending operation of a blanket salt pump,
starting operation of the primary pump 4,
starting operation of a secondary pump 14,
starting operation of a tertiary pump 44,
starting operation of a quaternary pump 64,
starting operation of a blanket salt pump.

The controller 50 is configured to perform one or more of:
adjusting primary pump speed to keep the fuel salt temperature at the fuel salt outlet 7 to approximately 700° C., preferably comprising decreasing primary pump speed to increase the fuel salt temperature at the fuel salt outlet 7, and increasing primary pump speed to decrease the fuel salt temperature at the fuel salt outlet 7,
adjusting a tertiary pump speed, which adjusts the liquid moderator level in the nuclear reactor core 2 and thus the reactivity, to keep the average temperature between the fuel salt inlet 6 and fuel salt outlet 7 to approximately 650° C., preferably comprising increasing moderator pump speed to increase reactivity and decreasing moderator pump speed to decrease reactivity,
adjusting secondary pump speed to keep the fuel salt temperature at the fuel salt inlet 6 to approximately 600° C., preferably comprising increasing the secondary pump speed to decrease the temperature of the fuel salt at the fuel salt inlet 6 and decreasing secondary pump speed to increase the temperature of the fuel salt at the fuel salt inlet 6,
adjusting moderator coolant pump speed to keep the temperature of the liquid moderator at the liquid moderator outlet of the nuclear reactor core 2 at approximately 40° C., preferably comprising increasing tertiary pump speed to decrease the temperature of the liquid moderator at the liquid moderator outlet of the nuclear reactor core 2, and decreasing tertiary speed to increase the temperature of the liquid moderator at the liquid moderator outlet of the nuclear reactor core 2.

In an embodiment, the controller 50 is configured to control the level of moderation in the nuclear reactor core 2 as a function of the data originating from within the vessel 1. hereto, the controller adjusts the level (amount) of liquid moderator in the nuclear reactor core 2. The level of liquid moderator and the reactor core can be adjusted by adjusting the speed of the moderator pump 44, with a higher speed resulting in a higher level of moderator in the reactor core and a lower speed resulting in a lower level of liquid moderator in the nuclear reactor core. This can be achieved, e.g. by allowing the liquid moderator to drain passively back into the liquid moderator drain tank 48 and having a separate gas connecting between the gas head volume of the liquid moderator tanks in the core 2 and the gas head of the liquid moderator tanks 48 the gas pressures above the liquid levels will be the same. Thus, the draining flow rate of the liquid moderator in the core will be proportional to the liquid moderator height in the core 2 and will converge on to the flow rate of the tertiary pump 44. A tuned flow restriction at or downstream of the liquid moderator outlet 47 allows for the desired relationship between liquid moderator level and tertiary pump flow rate or speed.

The nuclear reactor, comprises in an embodiment a breaker circuit arrangement 18,28,68 controlled by the controller 50 (a portion of the controller 50 can be arranged to be a part of the breaker circuit arrangement 18,28,68) and configured to connect and disconnect at least one of electric and/or electronic components 4,14,44 in the interior of the vessel 1 to and from a source of electric power 53 inside the vessel 1. The breaker circuit arrangement 18,28,68 is connected to the at least one sensor 9,22,41,49,59,79 that provides a signal representative of an operating condition of the nuclear reactor. The breaker circuit arrangement 18,28,68 is configured to open one or more or all circuit breakers 19,29,69 when the signal from the sensor 9,22,41,49,59,79 exceeds a safety threshold, preferably a safety threshold that indicates that the nuclear reactor is operated in an undo manner, a failure of a critical component has occurred, or another safety critical criterium has been exceeded.

In an embodiment, the breaker circuit arrangement 18,28,68 comprises a circuit breaker 19,29,69 controlled by one of the controllers 50. The nuclear reactor is configured to end the nuclear reaction and enter a safe state upon disconnecting the at least one of electric and/or electronic components 5,15,45,65 in the interior of the vessel 1 from the source of electric power 53. Thus, deactivating the electric power supply 53 will stop the operation of the nuclear reactor safely. As mentioned above, the liquid loops 3,13,43 in the interior are drained by gravity to their respective drain tanks 17, 27, 48, and the nuclear reaction will stop. Preferably the process of draining the liquid from the loops is passive, i.e. under the influence of gravity only.

The controller 50 is configured to start the operation of the nuclear reactor by connecting the electric and/or electronic components 5,15,45 to the source of electric power 53 by switching the breaker circuit arrangement 18,28,68 from an open position to a closed position. The controller 50 is configured to end the operation of the nuclear reactor by disconnecting the electric and/or electronic components 4,14,44,65 to the source of electric power 53 by switching the breaker circuit arrangement 18,28,68 from a closed position to an open position.

Each breaker circuit arrangement 18,28,68 comprises a circuit breaker 19,29,69 and one of the at least one (portion of) the controller 50. The controller 50 preferably comprises analog electronics and/or digital electronics that are configured to operate the respective circuit breaker 19,29,69 as either open or closed, the controller 50 preferably not comprising an electronic digital programmable computer.

The controller 50 is configured to autonomously and automatically stop the reactor operation by allowing the liquid to drain into the drain tank 17,48 under the influence of gravity, e.g. by opening a circuit breaker thus allowing the heat exchange liquids to drain into the respective drain tanks 17,27,48,67 under the influence of gravity when at least one or a combination of the reactor parameters, e.g. in the form of thermodynamic conditions differs from the acceptable operating values or ranges. Examples of acceptable operating values are (non-exhaustive list):
door to reactor vessel 1 closed (on, otherwise reactor shutdown)
leak detection sensors showing no leaks (on, otherwise reactor shutdown).
radiation detector below threshold (on, otherwise reactor shutdown).
first derivative of radiation detector below threshold (on, otherwise reactor shutdown)
reactor vessel furnace between 580° C. and 720° C. (on, otherwise reactor shutdown)
fuel salt inlet temperature between 580° C. and 720° C. (on, otherwise reactor shutdown)
fuel salt inlet temperature between 580° C. and 720° C. (on, otherwise reactor shutdown).
first coolant salt inlet temperature between 480° C. and 720° C. (on, otherwise reactor shutdown).
first coolant salt inlet temperature between 480° C. and 720° C. (on, otherwise reactor shutdown)
second coolant salt inlet temperature between 300° C. and 580° C. (on, otherwise reactor shutdown)
second coolant salt inlet temperature between 300° C. and 580° C. (on, otherwise reactor shutdown)
blanket salt inlet temperature between 580° C. and 720° C. (on, otherwise reactor shutdown)
blanket salt inlet temperature between 580° C. and 720° C. (on, otherwise reactor shutdown)
scrubber salt inlet temperature between 580° C. and 720° C. (on, otherwise reactor shutdown)
scrubber salt inlet temperature between 580° C. and 720° C. (on, otherwise reactor shutdown)
liquid moderator inlet temperature between 5° C. and 90° C. (on, otherwise reactor shutdown)
liquid moderator temperature between 5° C. and 90° C. (on, otherwise reactor shutdown)
liquid moderator coolant inlet temperature between 5° C. and 90° C. (on, otherwise reactor shutdown).
liquid moderator coolant inlet temperature between 5° C. and 90° C. (on, otherwise reactor shutdown)
speed of primary pump 4 below a predetermined threshold (on otherwise reactor shutdown),.
flow rate of primary heat exchange medium below a predetermined threshold (on otherwise reactor shutdown),
pressure of primary heat exchange medium below a predetermined threshold (on otherwise reactor shutdown).

In an embodiment, the nuclear reactor is configured to end the nuclear reaction and enter a safe state upon disconnecting the at least one electric and/or electronic components 5,15,45 in the interior from the source of electric power 53. In an embodiment, the nuclear reactor is configured to start operation when the electric and/or electronic components 5,15,45 are connected to the source of electric power 53, preferably by switching the circuit breaker 19, 29, 69 of the breaker circuit arrangement 18,28,68 from an open position to a closed position.

In an embodiment, the nuclear reactor is configured to end operation by disconnecting the electric and/or electronic components 5,15,45 to the source of electric power 53 by switching the circuit breaker 19,29,69 of the breaker circuit arrangement 18,28,68 from an open position to a closed position.

In an embodiment, the breaker circuit arrangement 18,28,68 is configured to require a safety threshold to be exceeded for a predetermined amount of time before switching a circuit breaker 19, 29, 69 to the open position, so that a transient outside of the safety threshold values of a few seconds does not trip the circuit breaker 19,29,69.

In an embodiment, the breaker circuit arrangement 18,28,68 is configured to use the first or second derivative of a signal from a one sensor 9,22,41,49,59,79, in addition, or instead of the value of the signal itself, for determining if a safety threshold has been exceeded.

In an embodiment, the procedure for starting up the nuclear reactor comprises connecting the controller 50 to the source of electrical power 53. Thereupon, the controller 50 starts heating the molten salt(s) electrically to reach a lower temperature threshold limit of the salt(s) and starts the pump(s) 4,14,44 when the salt(s) have reached sufficient temperature. If the restart occurs after a shutdown where the power was kept on and the salt(s) cools down over a longer period (hours or days) and gets below the lower threshold limits the heaters start heating again (of course assuming that the power is still connected), in order to prevent freezing of the salt(s). After a shutdown where the power was disconnected and the salt(s) cools down below threshold limits, once power is turned back on the controller 50 starts heating the salt(s) with the heaters to reach the minimum temperature limits as if it was the first time that the nuclear reactor is turned on, oblivious to the earlier shutdown, the controller 50 only taking into account predefined targets. Preferably, thresholds are set that do not allow the controller 50 to initiate a restart in certain scenarios, e.g. when the power to the reactor has been turned off and the salt has reached 900° C. and a mechanical thermo-switch (a switch that does not require electric power) is triggered. After such an event the reactor cannot be restarted because a limit at which is not deemed to be safe to restart has been reached. Similarly, in an embodiment, there is provided a thermo-switch to detect that the salt(s) have cooled down to below the melting point of the salt(s) since salt freezing could damage components. Another similar scenario relates to the detection of a leak by leak detection sensors, that once triggered to not allow the reactor to be turned on again. Preferably, the leak detection sensor is configured to operate without power, or with batteries, or by still capable of sensing a leak even after power is turned off and on.

Preferably, the nuclear reactor has a negative fuel reactivity coefficient, negative moderator reactivity coefficient (if present), and negative blanket reactivity coefficient (if present), to ensure stable power operation of the reactor core. Preferably, the nuclear reactor has a passive decay heat removal system.

In an embodiment, the fuel salt comprises fissile components, preferably comprising enriched lithium 7 fluoride, uranium tetrafluoride, low enriched uranium trifluoride (7LiF)—(UF4)—(UF3) salt.

In an embodiment, the nuclear reactor core 2 comprises a blanket (not shown) containing blanket salt, preferably, the blanket is connected to a blanket salt loop. The blanket salt is in an embodiment a molten salt comprising fertile components, preferably comprising enriched lithium 7 fluoride and/or thorium tetrafluoride (7LiF—ThF4) salt.

In an embodiment, electric power for sensors and electronics is behind the breaker circuit arrangement 18,28,68, so that the sensors and electronics remain operational when the circuit breaker 19,29,69 opens and cuts power to all electronic and electric components behind the breaker circular arrangement 18,28,68.

In an embodiment, the nuclear reactor operates according to an inherently safe process that directly provides a passive safety component during a specific failure condition in all operational modes.

In an embodiment, the nuclear reactor does not require any active intervention on the part of an operator or electrical/electronic feedback in order to bring the reactor to a safe shutdown state.

In an embodiment, the nuclear reactor is inherently safe, and preferably does not rely on active systems for ensuring reactor safety.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor, controller or other unit may fulfill the functions of several items recited in the claims. The mere fact that certain measures are recited in mutually different dependent claims does not indicate that a combination of these measures cannot be used to advantage.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure.

1. A molten salt nuclear reactor system for supplying heat to a consumer of heat (100), the molten salt nuclear reactor system comprising a molten salt nuclear reactor contained in a closed and preferably leaktight vessel (1), the molten salt nuclear reactor comprising:
a reactor core (2),
a liquid loop (3,43) for circulating a liquid through the reactor core (2), the liquid being a moderator or a mixture of molten salt and nuclear fuel,
the liquid loop (3, 43) comprises a circulation pump (4, 44) for circulating the liquid,
a drain tank (17,48), and
a controller (50) configured to monitor one or more reactor parameters,
the controller (50) having stored acceptable operating values or ranges for the one or more reactor parameters,
and the controller (50) being configured to:
autonomously stop reactor operation by allowing the liquid to drain into the drain tank (17, 48) under the influence of gravity when at least one or a combination of the reactor parameters differs from the acceptable operating values or ranges
characterized by the controller being configured to:
autonomously commence reactor operation by starting the
circulation pump (4,44) to pump liquid from the drain tank (17,48) to the liquid loop (3,43) and to circulate liquid in the liquid loop (3,43) when all reactor parameters and combinations thereof are in conformity with the acceptable operating values or ranges.

2. The molten salt nuclear reactor system according to claim 1, wherein the reactor parameters comprise one or more thermodynamic conditions of the liquid and/or a parameter indicating whether or not heat is consumed by the consumer of heat (100).

3. The molten salt nuclear reactor system according to claim 1, comprising one or more sensors (9,22,41,49,59,79) configured to issue a signal representative or indicative of the one or more reactor parameters to the controller (50)

4. The molten salt nuclear reactor system according to claim 3, wherein the controller (50) is configured to derive the one or more reactor parameters from the signals from the one or more sensors (9,22,41,49,59,79).

5. The molten salt nuclear reactor system according to claim 3, wherein the one of the one or more sensors comprise one or more of:
a temperature sensor (9,41,49,59) configured for sensing the temperature of the liquid, preferably at a position at or near a liquid inlet or outlet of the reactor core (2),
a temperature sensor configured for sensing of the atmosphere in the closed vessel (1),
a gas composition sensor configured for sensing the composition of the atmosphere in the closed vessel (1),
a radiation detection sensor configured for detecting a radiation level in the closed vessel (1),
a leak detection sensor, configured for detecting a leak in the liquid loop (3, 43),
a seismic sensor configured to detect seismic events affecting the molten salt nuclear reactor,
a pump speed sensor configured to detect the speed of the circulation pump (4, 44),
a flow rate sensor configured to detect the flow rate of the liquid circulating in the liquid circuit (3, 43),
a liquid level sensor, configured for detecting a liquid level in the drain tank (17,48),
a door sensor configured for detecting if a door in the closed vessel (1) is open or closed.

6. The molten salt nuclear reactor system according to claim 1, wherein the liquid loop (3,43), the drain tank (17,40) and the circulation pump (4,44) are configured to allow the liquid to drain to the drain tank (17,48) under the influence of gravity when the circulation pump (4,44) is stopped.

7. The molten salt nuclear reactor system according to claim 1, wherein the drain tank (17,48) is configured to remove heat from any liquid in the drain tank (17,48), preferably decay heat from a liquid containing fissile material, the drain tank preferably comprising passive cooling means for removing heat from the drain tank (17,18).

8. The molten salt nuclear reactor system according to claim 7, wherein the circulation pump (4,44) is of an open type that is open for passage of the liquid when the circulation pump (4,44) is not operating, and/or wherein the drain tank (17,40) is fluidically connected to the liquid loop (3,43) via a normally open valve (36) and/or wherein the drain tank (17,48) is part of the liquid loop (3,43).

9. The molten salt nuclear reactor system according to claim 1, wherein the liquid loop is either a moderator loop for circulating a liquid moderator, preferably comprising heavy water, or a heat exchange loop for circulating a heat exchange medium, preferably molten salt or a mixture of molten salt and nuclear fuel.

10. The molten salt nuclear reactor system according to claim 1, comprising the controller (50) being configured to derive the one or more reactor parameters and/or the one or more thermodynamic conditions from signals from sensors (9,22,41,49,59,79) that are arranged inside the vessel (1).

11. The molten salt nuclear reactor system according to claim 1, wherein the controller (50) comprises one or more of: analog electronics, digital electronics, mechanical logic, fluidic logic, a proportional-integral-derivative controller, a model predictive controller, a Boolean controller.

12. The molten salt nuclear reactor system according to claim 1, comprising:
a source of electrical power in the closed vessel (1) and an electric device (5,45,27,37),
at least one circuit breaker (19,29,69) arranged between the source of electrical power in the closed vessel (1) and the electric device (5,45,27,37), the electric device (4,44,27,37) being configured to stop a machine (5,25,45) driving the circulation pump (4,44) and/or to allow a normally open valve (36) to assume its normally open position.

13. The molten salt nuclear reactor system according to claim 12 wherein the controller (50) is configured to open the circuit breaker (19,29,69) to stop nuclear reactor operation by opening the at least one circuit breaker (19,29,69) to thereby interrupt supply of electric power to the electric device (4,44,27,37).

14. The molten salt nuclear reactor system according to claim 12, wherein the circuit breaker (19,29,69) and the controller (50) are part of a circuit breaker arrangement (18,28, 68′9).

15. The molten salt nuclear reactor system according to claim 12, wherein the electric device (5,45) is an electric motor operably coupled to the circulation pump (4,44), and/or wherein the electric device (27) is an actuator operably coupled to the normally open valve, and/or wherein the molten salt nuclear reactor system comprises a normally closed valve and a fluid driven motor, and the electric device (27) is an actuator operably coupled to the normally closed valve (26) in a fluid supply conduit of the fluid driven motor (25) that drives the circulation pump (4,44).

16. The molten salt nuclear reactor system according to claim 1, wherein the nuclear reactor is configured to end the nuclear reaction and enter a safe state upon the controller (50) ending reactor operation.

17. A method of controlling a molten salt nuclear reactor, the molten salt nuclear reactor being configured to supply heat to a consumer of heat (100) and being contained in a closed and preferably leaktight vessel (1), the molten salt nuclear reactor comprising:
a reactor core (2),
a liquid loop (3,43) for circulating a liquid through the reactor core (2), the liquid being a moderator or a mixture of molten salt and nuclear fuel,
the liquid loop (3, 43) comprises a circulation pump (4,44) for circulating the liquid,
a drain tank (17,48), and
a controller (50) having stored acceptable operating values or ranges for the one or more reactor parameters,
the method comprising:
the controller monitoring the one or more reactor parameters,
the controller (50) autonomously stopping reactor operation by allowing all the liquid to drain from the liquid loop (3,43) into the drain tank (17,48) under the influence of gravity when at least one or a combination of the reactor parameters differs from the acceptable operating values or ranges and/or
the controller (50) autonomously stopping reactor operation by allowing all the liquid to drain into the drain tank (17,48) under the influence of gravity when a reactor parameter indicates that no heat is consumed by the consumer of heat (100),
characterized by
the controller (50) autonomously commencing reactor operation by starting the circulation pump (4,44) to pump liquid from the drain tank (17,48) into the liquid loop (3,43) and to circulate liquid in the liquid loop (3,43) when at all reactor parameters and combinations thereof are in conformity with the acceptable operating values or ranges.

18. The according to claim 17, wherein the reactor comprises one or more sensors (9,22,41,49,59,79) configured to issue a signal representative or indicative of the one or more reactor parameters and wherein the method comprises deriving the one or more reactor parameters from the signals from the one or more sensors (9,22,41,49,59,79).

19. The method according to claim 17 or 18, comprising allowing the liquid to drain to the drain tank (17,48) under the influence of gravity when the circulation pump (4,44) is stopped.

20. The according to claim 17, wherein the reactor comprises at least one circuit breaker (19,29,69) arranged between a source of electrical power in the closed vessel (1) and an electric device (5,45,27,37), the electric device (4,44,27,37) being configured to stop a machine (5,25,45) driving the circulation pump (4,44) and/or to allow a normally open valve (36) to assume its normally open position, the method comprising opening the at least one circuit breaker (19,29,69) when at least one or a combination of the reactor parameters differs from the acceptable operating values or ranges and/or when a reactor parameter indicates that no heat is consumed by the consumer of heat (100).

21-38. (canceled)
